(19) United States
(12) Patent Application Publication
(10) Pub. No.: US 2026/0185439 A1
(43) Pub. Date: Jul. 2, 2026

(54) Textural Analysis of Rock Samples for Input into Well Drilling Management and Reservoir Property Assessment

(71) Applicant: Geolog S.r.l., San Giuliano Milanese (MI) (IT)

(72) Inventor: Antonio Calleri, San Giuliano Milanese (IT)

(21) Appl. No.: 19/436,047

(22) Filed: Dec. 30, 2025

(30) Foreign Application Priority Data
Dec. 30, 2024 (IT) 102024000030147

(51) Int. Cl. E21B 44/00; E21B 49/00; G06T 7/50; G06T 7/62

(52) U.S. Cl. CPC E21B 44/00; E21B 49/005; G06T 7/50; G06T 7/62; G06T 2207/10056; G06T 2207/20081

(57) ABSTRACT

A method for managing a well drilling process without interrupting the drilling operation includes: obtaining a sample of rock material over a well depth interval containing a plurality of rock particles and preparing the sample of rock material; performing an initial analysis of the prepared sample of rock material including a qualitative assessment to determine a type of rock material present, wherein preparing the sample of rock material further includes an additional sample preparation step if the rock material is determined to contain depositional grains; utilizing an imaging apparatus to perform at least one imaging operation on the prepared sample, generating an image; determining at least one representative parameter of the prepared sample, the representative parameter being related to a size, shape, and/or sorting of the rock particles in the image; and generating a control parameter based on the at least one representative parameter to adjust a well drilling process.

### CROSS-REFERENCE TO RELATED APPLICATIONS

This application claims priority to Italian Application No. 102024000030147, filed Dec. 30, 2024, which is incorporated herein by specific reference in its entirety.

### BACKGROUND OF THE DISCLOSURE

### Field of the Disclosure

The present invention relates to a method and an associated apparatus designed to determine control parameter(s) of a drilling process. In particular, the control parameter(s) is/are related to the operational parameters of a drilling operation and suitability of certain geological formations or subsoils as hydrocarbon reservoirs.

### The Relevant Technology

As is known, hydrocarbon or petroleum reservoirs are subsurface sources of petroleum, oil, natural gas, or other hydrocarbons. These reservoirs are generally found or discovered in specific geologic formations. The hydrocarbons may be contained in porous, permeable, and/or fractured geologic formations which allow for the accumulation of such hydrocarbons, forming reservoirs.

Understanding the differences in rock strata which form, make up, and/or constitute potential areas of interest for further development is central to any exploratory activities or field management. The analysis of sediment samples is an important tool in gaining a better understanding of reservoir characterization and quality.

It is important for a drilling operator/operation to have as much information and data related to the potential hydrocarbon reservoirs as possible. In the art, this information is generally obtained through laboratory measurements which involve expensive equipment and potential delays in drilling operations. In the art therefore, the necessity in obtaining the downhole information as well as the difficulty in obtaining the same information is the impetus for the present invention.

Returning from the bore hole, rock material is often the only physical material representative of the geologic conditions which is ripe for examination without halting or further delaying the drilling operation.

The applicant has noted the issues in the art and has developed the present methodology and apparatus to overcome the inefficiencies and operational difficulties in determining the geological conditions at the drill bit.

### SUMMARY OF THE DISCLOSURE

The disclosed invention comprises a method for managing a well drilling process without interrupting the drilling operation.

Preferably, the method comprises the step of obtaining, by a sample collection apparatus, a sample of rock material over a well depth interval containing a plurality of rock particles and preparing said sample of rock material.

Preferably, performing an initial analysis of a prepared sample of rock material comprises a qualitative assessment to determine a type of rock material present in the prepared sample.

Preferably, said preparing said sample of rock material further comprises an additional sample preparation step if the rock material is determined to contain depositional grains. Preferably, the method further comprises utilizing an imaging apparatus to perform at least one imaging operation on said prepared sample, generating an image.

Preferably, the method further comprises determining, by an image analysis algorithm, at least one representative parameter of the prepared sample.

Preferably, said representative parameter is related to a size, shape, and/or sorting of the rock particles in said image.

Preferably, the method further comprises generating, by a processor, a control parameter based on said at least one representative parameter to adjust a well drilling process.

Preferably, the control parameter is indicative of further exploration of the well for hydrocarbon extraction.

Preferably, the image analysis algorithm is configured to find individual particles by means of a special purpose algorithm.

Preferably, said size is defined according to a maximum dimension of the rock material.

Preferably, said shape is determined according to a minimum bounding rectangle.

Preferably, the method further comprises wherein the image analysis algorithm utilizes artificial intelligence or machine learning to extract and determine said representative parameter.

Preferably, said qualitative assessment is indicative of the prepared sample representing drill cuttings.

Preferably, the control parameter is used to adjust drilling parameters of the drilling operation.

Preferably, the drilling parameters of the drilling operation comprise a rate of penetration parameter.

Preferably, the drilling parameters of the drilling operation comprise a weight on hook parameter.

Preferably, the drilling parameters of the drilling operation comprise a weight on bit parameter.

Preferably, the drilling parameters of the drilling operation comprise a standpipe pressure parameter.

Preferably, the drilling parameters of the drilling operation comprise a revolutions per minute parameter.

Preferably, the drilling parameters of the drilling operation comprise a torque parameter.

Preferably, the additional sample preparation step comprises a disaggregation and additional cleaning of the rock material, obtaining a prepared sample representing depositional grains.

Preferably, the control parameter is at least one of a permeability or porosity value of said well depth interval.

Preferably, the imaging apparatus comprises a microscope or similar device capable of imaging the depositional grains in the prepared sample.

Preferably, the microscope performs the imaging operation at magnifications substantially between 20× to 2000×.

Preferably, the permeability is calculated according to an empirical equation containing a dependence upon the representative parameter.

Preferably, the disclosed invention comprises an apparatus for performing the method disclosed herein.

### BRIEF DESCRIPTION OF THE FIGURES

This description will refer to the annexed drawings, which are provided as explanatory and non-limiting examples of systems and methods according to the invention, wherein:

FIG. 1 shows a simplified schematic diagram of a system in which the invention can be implemented;

FIG. 2 shows a block diagram of a methodology in accordance with the invention;

FIG. 3 shows a block diagram of an additional methodology in accordance with an embodiment of the invention;

FIG. 4 shows a simplified schematic diagram of an analysis apparatus in accordance with the invention.

### DETAILED DESCRIPTION

The terminology contained herein is to be understood as applied in fields of use related to well drilling and subsurface geology.

The term texture is known in the art and intended to mean a measure of at least a size and shape of a rock fragment, grain, piece, or the like.

A sample in the context of this description is intended to mean a set or subset of rock material that is obtained from a drilling mud to represent the geological composition of the rock material over a sampled interval.

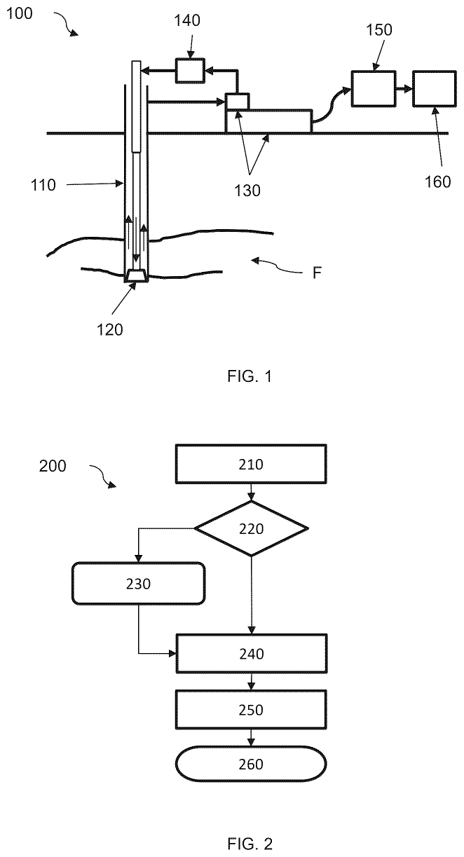

The mud circuit shown in FIG. 1 defines the flow of the drilling fluid or drilling mud for a well drilling operation 100. The drilling mud is pumped by the mud pump 140 down the bore hole 110 to the drill bit 120 and returns to the shale shaker 130.

While flowing through the mud circuit at drill bit 120, the drilling mud assimilates rock material from geologic formations F. The mud acts as a rock material transport medium to evacuate the bore hole 110 of the excavated rock material, while also lubricating and cooling the system. The mud circuit then makes use of shale shakers 130 and/or other devices or processes to remove the rock material from the mud in the mud circuit before recirculating the fluid.

The rock material can generally be classified into two different groups: rock material of a certain dimension that represents the drilling process, also called drill cuttings or simply cuttings; and rock material which represents the state of the material as originally deposited before a lithification or similar geologic process occurred, also known as depositional grains or detrital grains.

The cuttings provide valuable information that can be used to inform and optimize the drilling process. Drilling process parameters include but are not limited to a weight on bit (WOB) and revolutions per minute (RPM), among others as known in the art. For example, an increase in the amount of large, angular cuttings may indicate that the drill bit is encountering a hard, abrasive formation, prompting the driller to adjust the WOB and RPM to maintain optimal drilling conditions and prevent excessive wear on the drill bit. Conversely, an increase in the amount of fine, rounded cuttings may indicate that the drill bit is experiencing excessive wear, prompting the driller to adjust drilling parameters to reduce the risk of bit failure. Additionally, changes in the composition of the cuttings, such as an increase in the amount of shale or sand, can indicate changes in the formation geology, allowing the driller to adjust the drilling parameters to optimize drilling efficiency and minimize the risk of wellbore instability.

Depositional grains provide valuable information that can be used to better understand the geological state at the drill bit. The depositional grains have physical characteristics which reveal information about the sediment as originally deposited. The grain texture can be analyzed to reconstruct the geological state at the drill bit depth. The grain texture, as known in the art, can be described by the physical characteristics of the grain itself. The texture is defined in this description as at least a size and shape of a grain.

The analysis may allow for the identification of geological features such as sand bodies, shale layers, and/or fault zones. The mean grain size, grain shape, sorting coefficient, skewness, and/or other statistical parameters of the sample can be used to infer porosity and permeability values for the sedimentary system, as well as processing parameters for the drilling operation. The porosity and permeability values for a sedimentary system are key parameters in the exploration of a hydrocarbon petroleum system, due to their capabilities of characterizing the ability of a fluid to flow in the rock structure.

The rock material from the drilling mud needs to be processed at a processing area 150, 160. The processing area 150, 160 comprises a preparation station 150 and an analysis station 160.

Preparation station 150 may be configured to perform a number of preparation steps or stages to fully and adequately prepare a sample of rock material for further analysis.

The rock material obtained from the shale shaker 130 is generally covered with residual drilling mud. It is necessary to fully remove the drilling mud from the rock material before an analysis can be performed by analysis station 160.

Depending upon the type of drilling mud used, generally between a water-based or oil-based fluid, a wash may be required. Preparation station 150 may be configured to perform an initial wash to remove mud remaining on the rock material after the shale shaker 130. Additional washing steps, such as deflocculation, an ultrasonic bath, an alcohol rinse, or similar may be added as necessary to obtain an acceptable sample free of contamination.

The preparation station 150 may also provide drying elements. The drying elements may consist of an oven or similar structure to remove remaining fluid from the wash.

An exemplary method for analyzing the geological samples is shown in FIG. 2. Method 200 begins with step 210, preparing geological samples. The samples may include samples taken from a shale shaker 130 or other sampling technique including core samples, side-wall core samples, outcrop samples or similar. A sample preparation action may be performed. The sample preparation stage may comprise obtaining, cleaning, and/or drying stages performed at the sample preparation station 150.

If the drilling mud is an oil-based drilling mud, an initial wash cycle is required. The initial wash cycle is used to remove any remnants of the oil-based drilling mud still clinging onto the rock material in the sample. The initial wash cycle comprises a wash adapted to the oil-based drilling mud as is known in the art.

If the drilling mud is water-based or after the initial wash cycle has been completed, the sample preparation may continue to a drying cycle. The drying cycle may occur in an oven at a temperature substantially similar to 50 degrees Celsius for an extended period. The extended period may opportunely last between 15 minutes and 1 hour. The weight of the sample may be obtained after the drying cycle.

In a particular embodiment of the invention, step 220 comprises a sample type inspection and/or initial analysis of the rock sample. The sample type inspection and/or initial analysis of the rock sample comprises a qualitative assessment of the rock sample to determine the type of rock material present in the rock sample. This assessment may be performed by a human technician. Alternatively, the assessment may be performed by a computer vision program configured to determine makeup of the sample of rock material.

The qualitative assessment of the rock sample may comprise assessments of the sample dimensions and/or the form or shape of the rock sample. The rock sample may comprise singular grains or cemented grains. The Applicant notes that depositional grains are typically characterized by a form having between a sub-angular to a rounded shape. Cuttings or cemented cuttings fragments are typically characterized by a more angular or sharp form. This form characterization may be defined as in the Shepard and Young comparison chart. The sample type inspection may be chosen depending upon the dominant characteristics in the sample of rock material.

The qualitative assessment may be informed by professional experience, bore hole 110 intervals, and/or prior geological knowledge. Given prior geological knowledge, certain well depths or lithological features may be preselected or prioritized for different or a combination of assessments as further detailed.

Alternatively, in a particular embodiment of the invention, step 220 comprises a selection of a type of analysis to be performed. The selection determines, based on a criteria or selection by an end user, a type of analysis to be performed.

The sample of rock material, if determined to contain depositional grains or chosen to undergo a depositional grain analysis, may undergo additional preparation at step 230 to obtain depositional grain specific information. The processing of depositional grains comprises the steps of disaggregation and further cleaning.

Disaggregation may comprise mechanical disaggregation. Mechanical disaggregation may subject the rock sample to a mechanical force, such as vibration or agitation, in order to separate the individual depositional grains from each other. Additional methods of disaggregation as known in the art are possible.

In an embodiment, the mechanical disaggregation may be performed by the human technician via a mortar and pestle. It is important to not damage the depositional grains when performing the mechanical disaggregation process. For example, attention should be paid to not use pressure when using the mortar and pestle, so as to keep the grains intact while separating them.

In an embodiment, the mechanical disaggregation may be performed with a sonic bath. The applicant has noted a sonic bath for about 10 minutes may provide the requisite disaggregation depending upon the particular type and structure of the cemented rock sample.

The mechanical disaggregation may be preferably performed in a multi-stage process utilizing the mortar and pestle before subsequently submerging the rock sample in a sonic bath for a final disaggregation.

Further cleaning may comprise de-flocculation by means of a typical de-flocculation chemical. In a particular embodiment of the invention, the de-flocculation chemical may be sodium hexametaphosphate or similar.

After an application of a typical de-flocculation chemical, an additional rinsing operation may be required. In a particular embodiment, the additional rinsing operation comprises an ultrasonic bath and a rinse with denaturalized alcohol. The ultrasonic bath may last 1-15 minutes. After a rinse with denaturalized alcohol, the disaggregated depositional grains may undergo a second drying cycle, this time for a more substantial amount of time. The second drying cycle may last in the order of 1-2 hours. An additional weight measurement of the sample may be obtained.

The disaggregated grains may preferably be checked for proper disaggregation after the completion of the additional preparation step 230. The check may be completed by the human technician under a relevant magnification to determine the status of the disaggregated depositional grains. Proper processing will result in accurate granulometry of the depositional grains. The disaggregation process should not break the deposition grain structure. If further processing is necessary, the rock sample may be returned for further preparation.

The depositional grains are then sieved into sub-groups by dimension. The sieving may occur via a plurality of different-sized sieves to record physical parameters for different dimensions of rock material groups. In a particular embodiment of the invention, the sieve sizes may range from about a mesh size of 2 mm to 0.045 mm. In practice, the mesh sizes correspond to wentworth size classes of sand and silt. Preferably, the depositional grains show characteristic sizes down to about 10 microns.

In contrast to the processing and preparation of the depositional grains in processing area 150, drill cuttings are not disaggregated, crushed, sieved, or any similar operation.

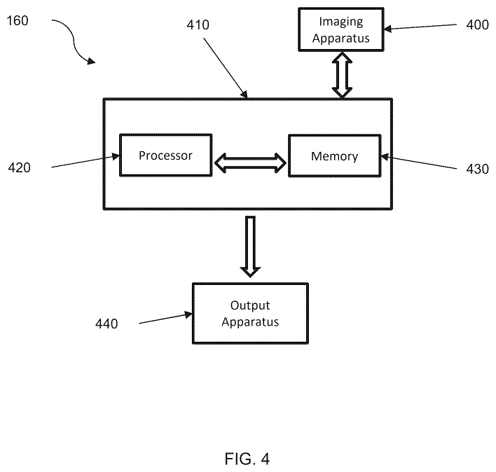

Once a prepared sample of either depositional grains or cuttings is obtained, at least one imaging operation is performed at step 240. The imaging operation is performed using an imaging apparatus 400 shown in FIG. 4 to generate an image. The imaging operation 240 is based on the rock material being imaged, where the scale of the image is adapted to the sample size dimensions.

The magnification of imaging operation 240 may vary in accordance with the sieve size. As an example, the highest magnification may be reserved for creating an image of the group corresponding to a mesh size of 0.045 mm, while the largest sieve size, about 2 mm, may correspond to the least amount of magnification. The associated weights for each group of sorted or sieved depositional grains may be obtained.

The imaging operation is performed in such a way as to allow the determination of physical characteristics of the sample rock material based on the resulting image. The physical characteristics include but are not limited to at least one of a size, shape, and/or sorting of the rock particles.

Step 250 is an analysis step based on the rock particles in the generated image. The analysis step involves the execution of an image analysis algorithm.

The image analysis algorithm is configured to extract individual grains or cuttings from the generated image. The image analysis algorithm is preferably any known image analysis algorithm. In a particular embodiment, the image analysis algorithm is one which utilizes machine learning or artificial intelligence to extract individual grains or cuttings. The machine learning algorithm or artificial intelligence algorithm may operate using pretrained weights or other methods adapted to computer vision as known in the art.

The image analysis algorithm, based on the extracted grain information, may also determine at least one representative parameter of the sample rock material. Preferably, the representative parameter is related to the size, shape, and/or sorting of the rock particles in the image generated at 240 or any statistical quantity thereof.

The particle size can be defined using several different methods. Specifically, the size of a particle can be defined as the maximum dimension, such as the longest axis or diameter, or as a mean dimension, of a particle. Alternatively, the size of a particle can be determined using other methods, such as equivalent spherical diameter or other statistical measures that provide a representative value of the particle's dimensions. In all cases, the size of a particle is intended to provide a quantitative description of its physical dimensions and can be used to characterize and distinguish between particles of different dimensions.

The particle shape may be determined according to techniques known in the art. More specifically, the shape can be determined using methods such as minimum bounding rectangles, largest perpendicular chords, or other similar methods. The method may be adapted for estimating the sphericity or lack thereof of a particular particle in the sample of rock material.

The particle sorting may be determined based on sample statistics of particle size. The sorting coefficient may be calculated according to relationships known in the art. In a particular embodiment, the sorting coefficient may be calculated using the Folk & Ward relationship reproduced below:

$$σφ = \frac{( {φ}_{84} - {φ}_{16} )}{4} + \frac{( {φ}_{95} - {φ}_{5} )}{6.6}$$

Where the sorting coefficient σφ is related to φₙ which refers to the particle diameters at the 5^{th}, 16^{th}, 84^{th}, and 95^{th} percentiles respectively.

The porosity of a geological formation is an important predictive value of the economic feasibility of the well. Porosity is defined as the fraction of the volume not occupied by solid matter and can be expressed as a fraction or percentage. The shape and roundness of particles will affect the way particles are able to pack together. Well rounded, spherical particles tend to pack together in a tighter arrangement than more angular, less spherical particles. Despite being a good indication of potential, porosity does not help develop an understanding of the underlying pore size, distribution, or the connectivity of pores.

Another valuable parameter correlated to geological formation properties is permeability. Permeability is defined as the ability of a porous material to allow for a fluid flow through said material. Empirical data suggests permeability tends to increase with increasing particle size due to capillary pressure. In the field of oil and gas, this value is naturally a key aspect to determining parameters for the drilling operation.

In the art, there are equations which represent different models which define permeability in relation to empirical studies. An empirical estimation for permeability (k) can be obtained using representative parameters of the depositional grains.

$$Krumbein \& Monk and Beard \& Weyl \qquad k = 760 {d}_{g}^{2} exp ( 1 - 1.31 {σ}_{d} )$$

$$Berg 1970 \qquad k = 80.8 {∅}^{5.1} {d}^{2} {e}^{- 1.385 p}$$

$$Van Baaren \qquad k = 10 {D}_{dom}^{2} {C}^{- 364} {∅}^{( m + 3.64 )}$$

The analysis of step 250, then, may determine a representative parameter of the sample of rock material. In a particular embodiment of the invention, the representative parameter may be one of a porosity or a permeability of the rock formation from which the depositional grain sample is derived/obtained.

Drill cuttings, based on their shape, size, structure, and/or sorting, report a general quality of the drilling process. These parameters reveal how the current process parameters translate to the actual drilling of the geological formation; they help to determine drill bit efficiencies, hole cleaning efficiencies, and best practices for the drilling process. For an analysis of drill cuttings, the representative parameter(s) is/are at least one of said shape, size, structure, and/or sorting.

Step 260, based on the at least one representative parameter, generates a control parameter. The control parameter is indicative of further exploration of the well for hydrocarbon extraction.

In an embodiment of the invention, when the rock sample comprises cuttings, the control parameter may consist of an operational parameter of the drilling process. The control parameter may be an adjustment to drilling process parameters such as RPM, ROP, or the like.

In an embodiment of the invention, when the rock sample comprises depositional grains, the control parameter may be a signal based on the permeability or porosity of the geological formation being above a threshold value. The signal may be in the form of a visual notice, an auditory notice, a digital transmission to a 3^{rd} party, or similar to indicate the need for further exploration of the well for hydrocarbon extraction.

In an embodiment, the generated control parameter may alternatively be used to generate graphics. The graphics are generated based on the at least one representative parameter. In a particular embodiment of the invention, the graphics may comprise plotted data points, down hole curves, size shape and sorting histograms, sample porosity and/or permeability charts, or the like. The graphics generated may provide essential insights that can be utilized to optimize drilling parameters.

In another embodiment of the invention, the control parameter may comprise the porosity and/or permeability values of the rock formation, F. The porosity and/or permeability of the rock formation F are indicative values of the suitability of the formation for reservoir development.

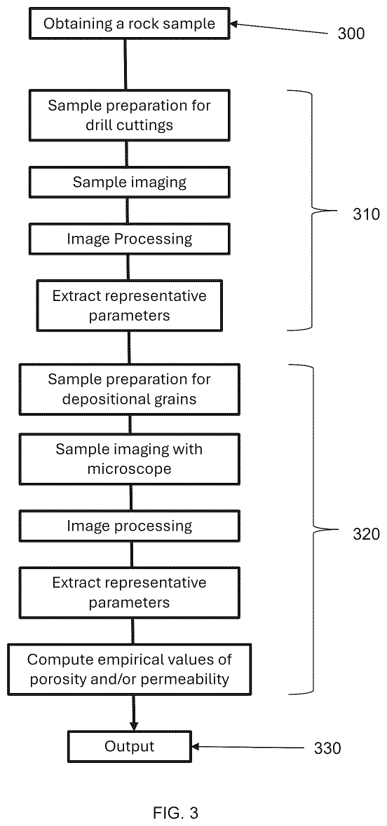

In an alternative embodiment of the invention shown in FIG. 3, the methodology shown in FIG. 2 may be completed consecutively. The analysis methodologies for drill cuttings and depositional grains are not mutually exclusive. The drill cuttings analysis 310 does not destructively modify the cuttings themselves. Conversely, the depositional grain analysis 320 modifies the physical structure of the drill cuttings during the sample preparation. Due to the non-destructive aspects of the drill cuttings analysis 310, in the case where both analyses are required, the depositional grain analysis 320 may be performed following the drill cuttings analysis 310.

In the case where both analyses 310, 320 are performed, the sample type inspection at step 220 may be avoided. Due to the stages of analysis being performed on a single sample of rock material, the analysis may accept a sample from the drilling mud and perform the cuttings analysis 310 before breaking up the cuttings into the smaller depositional grains to perform the depositional grain analysis 320.

Based on performing the analyses 310, 320, the output 330 of the methodology comprises a combination of outputs from individual analyses 310, and 320 as described for step 260.

FIG. 4 shows a more detailed view of the analysis station 160 which may be used to execute the methodology in FIGS. 2 and 3. The analysis station 160 comprises an imaging apparatus 400 and a computation device 410.

The imaging apparatus 400 is configured to perform the imaging operation 240 on the sample of rock material. The imaging apparatus 400 preferably takes the form of an imaging sensor and an adapted lens assembly.

In a particular embodiment of the present invention, the adapted lens assembly is a camera lens. The camera lens may be a commercially available lens or a specialty lens depending upon the required optical characteristics.

In a particular embodiment of the invention, the adapted lens assembly is a microscopic lens. The microscopic lens is configured to accurately image rock material with dimensions on the same order of magnitude as depositional grains. The microscopic lens may have a magnification substantially between 20× and 4000×. The magnification of the microscopic lens is chosen based upon the size of rock particles being imaged.

The imaging apparatus 400 may be configured with one or both adapted lens assemblies. In a particular embodiment of the invention, both lens assemblies are available to perform an analysis of the rock samples coming from the drilling mud. In the case of samples obtained not from a target location or which do not represent depositional grains, the imaging apparatus 400 may use the camera lens only. Oppositely, if the rock samples represent the depositional grains, the microscopic lens may be utilized instead. By providing both lenses, the operation may monitor and analyze either or both types of rock samples individually or in sequence.

The imaging apparatus 400 may additionally provide illumination to the samples. The samples may be illuminated by a light source which can provide reflected light or transmitted light.

The imaging apparatus 400 may provide different wavelengths of light to improve the resulting image. In a particular embodiment of the invention, the imaging apparatus 400 may be configured to function in additional bands of the electro-magnetic spectrum.

The computation device 410 comprises at least a processor 420 and memory 430 that is configured to execute the computer implemented processes described herein. The computation device 410 may be configured to run a neural network or process the images generated by the imaging apparatus 400. The memory 430 may comprise non-volatile storage as well as traditional volatile memory. The algorithm may be stored on the local memory non-volatile storage, or as an alternative on a network or other known storage method for computer instructions.

Output apparatus 440 is configured to generate the control parameter based on at least one representative parameter to adjust a well drilling process. The output apparatus 440 may be a port, connection, hub, or similar physical connection. In addition, or as an alternative, the output apparatus may be defined by data or network transfer protocols which are used to transmit or otherwise send data. Output apparatus 440 may be a physical display device designed to render visuals like plotted data points, down hole curves, and histograms as known in the art. Output device 440 can present charts and/or other related visuals as results from said generated control parameter.

1. A method for managing a well drilling process without interrupting the drilling operation comprising the steps of:
obtaining, by a sample collection apparatus, a sample of rock material over a well depth interval containing a plurality of rock particles and preparing said sample of rock material;
performing an initial analysis of a prepared sample of rock material comprising a qualitative assessment to determine a type of rock material present in the prepared sample, wherein said preparing said sample of rock material further comprises an additional sample preparation step if the rock material is determined to contain depositional grains;
utilizing an imaging apparatus to perform at least one imaging operation on said prepared sample, generating an image;
determining, by an image analysis algorithm, at least one representative parameter of the prepared sample, said representative parameter being related to a size, shape, and/or sorting of the rock particles in said image; and
generating, by a processor, a control parameter based on said at least one representative parameter to adjust a well drilling process, wherein the control parameter is indicative of further exploration of the well for hydrocarbon extraction.

2. The method according to claim 1, wherein the image analysis algorithm is configured to find individual particles by means of a special purpose algorithm.

3. The method according to claim 1, wherein said size is defined according to a maximum dimension of the rock material, and wherein said shape is determined according to a minimum bounding rectangle.

4. The method according to claim 1, wherein the image analysis algorithm utilizes artificial intelligence or machine learning to extract and determine said representative parameter.

5. The method according to claim 1, wherein said qualitative assessment is indicative of the prepared sample representing drill cuttings.

6. The method according to claim 5, wherein the control parameter is used to adjust drilling parameters of the drilling operation.

7. The method according to claim 6, wherein the drilling parameters of the drilling operation comprise at least one of a rate of penetration parameter, a weight on hook parameter, a weight on bit parameter, a standpipe pressure parameter, a revolutions per minute parameter, or a torque parameter.

8. The method according to claim 1, wherein the additional sample preparation step comprises a disaggregation and additional cleaning of the rock material, obtaining a prepared sample representing depositional grains.

9. The method according to claim 8, wherein the control parameter is at least one of a permeability or porosity value of said well depth interval.

10. The method according to claim 9, wherein the imaging apparatus comprises a microscope or similar device capable of imaging the depositional grains in the prepared sample.

11. The method according to claim 10, wherein the microscope performs the imaging operation at magnifications substantially between 20× to 2000×.

12. The method according to claim 11, wherein the permeability is calculated according to an empirical equation containing a dependence upon the representative parameter.

13. An apparatus for performing the method according to claim 1.
